(19) United States
(12) Patent Application Publication
(10) Pub. No.: US 2026/0153035 A1
(43) Pub. Date: Jun. 4, 2026

(54) MECHANICAL LOCKING DESIGN FOR COMPOSITE STRUCTURAL VANE

(71) Applicant: RTX Corporation, Farmington, CT (US)

(72) Inventor: Thomas J. Robertson, Glastonbury, CT (US)

(73) Assignee: RTX Corporation, Farmington, CT (US)

(21) Appl. No.: 18/968,590

(22) Filed: Dec. 4, 2024

(51) Int. Cl. F01D 9/04

(52) U.S. Cl. CPC F01D 9/042; F05D 2220/32; F05D 2240/12

(57) ABSTRACT

A composite vane with a locking feature including a leading edge and a trailing edge opposite chordwise from the leading edge; a radially inner attachment region opposite spanwise from a radially outer attachment region; a span dimension extending between the radially inner attachment region and the radially outer attachment region; a chord dimension extending between the leading edge and the trailing edge; a pressure side opposite a suction side of the composite vane; a dovetail section formed within the composite vane proximate the radially outer attachment region; a shoe member in operative communication with the dovetail section; a boot in operative communication with an inner portion opposite spanwise from the dovetail portion; and a failsafe fastener in operative communication with the boot and the inner portion of the composite vane.

### BACKGROUND

The present disclosure is directed to the improved composite vane with mechanical locking feature.

Current gas turbine engine design, as seen in FIG. 1 through FIG. 4a, includes a design with variable or non-variable fan exit guide vanes (FEGV). The fan F is positioned within the fan duct FD proximate the engine inlet EI. The fan exit guide vanes (FEGV) are downstream from the fan F and located forward of the bypass duct BD.

A current FEGV pattern is created to minimize airflow back pressure adverse effect on fan blades F caused by the downstream presence of nacelle N bypass duct BD elements (FIG. 2), such as the upper and lower bifurcation (BiFi), air-to-oil cooler (AOC), and environmental control system inlet (ECS).

As seen in FIG. 3, the FEGV is arranged as an array with a circumferential pattern CP made up of vanes V that can translate the structural load path LP shown as arrows in FIG. 4. All vane types are designed with the same cross sectional monolithic load carrying features (FIG. 4a). Additionally, the FEGV pattern aims to optimize the fan duct performance characteristics of the gas turbine engine.

Case deflections during an ultimate load condition overchallenge traditional structural adhesive bonds and allow vanes to dislodge from metallic bases. Dislodged vanes cannot carry the load during a fly home mission. An outer vane mount location has limited radial space for adhesive bond area due to engine mount proximity to outer flow path.

### SUMMARY

In accordance with the present disclosure, there is provided a composite vane with a locking feature comprising a leading edge and a trailing edge opposite chordwise from the leading edge; a radially inner attachment region opposite spanwise from a radially outer attachment region; a span dimension extending between the radially inner attachment region and the radially outer attachment region; a chord dimension extending between the leading edge and the trailing edge; a pressure side opposite a suction side of the composite vane; a dovetail section formed within the composite vane proximate the radially outer attachment region; a shoe member in operative communication with the dovetail section; a boot in operative communication with an inner portion opposite spanwise from the dovetail portion; and a failsafe fastener in operative communication with the boot and the inner portion of the composite vane.

A further embodiment of any of the foregoing embodiments may additionally and/or alternatively include the shoe member comprises a receiver, the receiver is configured to couple with the dovetail section.

A further embodiment of any of the foregoing embodiments may additionally and/or alternatively include the dovetail section comprises a wedge portion, the wedge portion being configured to cooperate with the receiver to form an interference fit between the shoe member and the dovetail section.

A further embodiment of any of the foregoing embodiments may additionally and/or alternatively include the boot is configured to receive the inner portion of the composite vane.

A further embodiment of any of the foregoing embodiments may additionally and/or alternatively include the composite vane with the locking feature further comprising an adhesive in operative communication between the shoe member and the dovetail section.

A further embodiment of any of the foregoing embodiments may additionally and/or alternatively include the shoe member is configured slidable onto the dovetail section.

A further embodiment of any of the foregoing embodiments may additionally and/or alternatively include the boot is configured to couple with the failsafe fastener and configured to couple with the inner portion with an adhesive.

In accordance with the present disclosure, there is provided a fan exit guide vane system with a locking feature for a gas turbine engine, the fan exit guide vane system comprising a fan located within a fan duct; and an array of composite fan exit guide vanes supported within the fan duct downstream from the fan, the array of composite fan exit guide vanes span across the fan duct attached to a radially inner surface of the fan duct and a radially outer surface of the fan duct; wherein each composite fan exit guide vane of the array of composite fan exit guide vanes comprises a leading edge and a trailing edge opposite chordwise from the leading edge; a radially inner attachment region opposite spanwise from a radially outer attachment region; a span dimension extending between the radially inner attachment region and the radially outer attachment region; a chord dimension extending between the leading edge and the trailing edge; a pressure side opposite a suction side of the composite fan exit guide vane; a dovetail section formed within the composite fan exit guide vane proximate the radially outer attachment region; a shoe member in operative communication with the dovetail section; a boot in operative communication with an inner portion opposite spanwise from the dovetail portion; an adhesive in operative communication between the shoe member and the dovetail section, the adhesive in operative communication between the boot and the inner portion; and a failsafe fastener in operative communication with the boot and the inner portion of the composite fan exit guide vane.

A further embodiment of any of the foregoing embodiments may additionally and/or alternatively include the shoe member comprises a receiver, the receiver is configured to couple with the dovetail section.

A further embodiment of any of the foregoing embodiments may additionally and/or alternatively include the dovetail section comprises a wedge portion, the wedge portion being configured to cooperate with the receiver to form an interference fit between the shoe member and the dovetail section.

A further embodiment of any of the foregoing embodiments may additionally and/or alternatively include the boot is configured to receive the inner portion of the composite vane.

A further embodiment of any of the foregoing embodiments may additionally and/or alternatively include the boot is configured to couple with the failsafe fastener.

A further embodiment of any of the foregoing embodiments may additionally and/or alternatively include the shoe member is configured slidable onto the dovetail section.

In accordance with the present disclosure, there is provided a process for a composite fan exit guide vane with a locking feature comprising locating a fan within a fan duct; supporting an array of composite fan exit guide vanes within the fan duct downstream from the fan; attaching the array of composite fan exit guide vanes spanned across the fan duct to a radially inner surface of the fan duct and a radially outer surface of the fan duct; coupling a radially inner attachment region of each composite fan exit guide vane of the array of composite fan exit guide vanes in operative communication with the radially inner surface of the fan duct; coupling a radially outer attachment region of each composite fan exit guide vane of the array of composite fan exit guide vanes in operative communication with the radially outer surface of the fan duct; forming a dovetail section within the composite fan exit guide vane proximate the radially outer attachment region; coupling a shoe member in operative communication with the dovetail section; coupling a boot in operative communication with an inner portion opposite spanwise from the dovetail portion; attaching an adhesive in operative communication between the shoe member and the dovetail section, the adhesive in operative communication between the boot and the inner portion; and coupling a failsafe fastener in operative communication with the boot and the inner portion of the composite fan exit guide vane.

A further embodiment of any of the foregoing embodiments may additionally and/or alternatively include the process further comprising forming a receiver in the shoe member and configuring the receiver to couple with the dovetail section.

A further embodiment of any of the foregoing embodiments may additionally and/or alternatively include the process further comprising forming a wedge portion in the dovetail section; configuring the wedge portion to cooperate with the receiver; and forming an interference fit between the shoe member and the dovetail section.

A further embodiment of any of the foregoing embodiments may additionally and/or alternatively include the process further comprising configuring the boot to receive the inner portion of the composite vane.

A further embodiment of any of the foregoing embodiments may additionally and/or alternatively include the process further comprising coupling the boot with the failsafe fastener.

A further embodiment of any of the foregoing embodiments may additionally and/or alternatively include the process further comprising configuring the shoe member slidable onto the dovetail section.

A further embodiment of any of the foregoing embodiments may additionally and/or alternatively include the process further comprising employing radially inner attachment fasteners proximate the radially inner attachment region; employing radially outer attachment fasteners proximate the radially outer attachment region; attaching the radially outer attachment fasteners to the shoe member; and coupling the boot with the radially inner attachment fasteners to secure the composite fan exit guide vane with the radially inner surface.

Other details of the composite vane with mechanical locking feature are set forth in the following detailed description and the accompanying drawings wherein like reference numerals depict like elements.

### BRIEF DESCRIPTION OF THE DRAWINGS

FIG. 1 is a schematic representation of a prior art gas turbine engine.

FIG. 2 is a schematic representation of a prior art gas turbine engine.

FIG. 3 is a schematic representation of a prior art fan exit guide vane pattern.

FIG. 4 is a schematic representation of a prior art fan exit guide vane with load path.

FIG. 4a is a sectional view schematic representation of the prior art fan exit guide vane FIG. 4.

FIG. 5 is a schematic representation of an exemplary fan exit guide vane.

FIG. 5a is a sectional view schematic representation of the fan exit guide vane FIG. 5.

FIG. 6 is a schematic representation of exemplary fan guide exit vane with locking features.

FIG. 7 is a cross sectional view schematic representation of exemplary fan guide exit vane with exemplary locking features.

FIG. 8 is a schematic representation of exemplary assembly of the exemplary locking features.

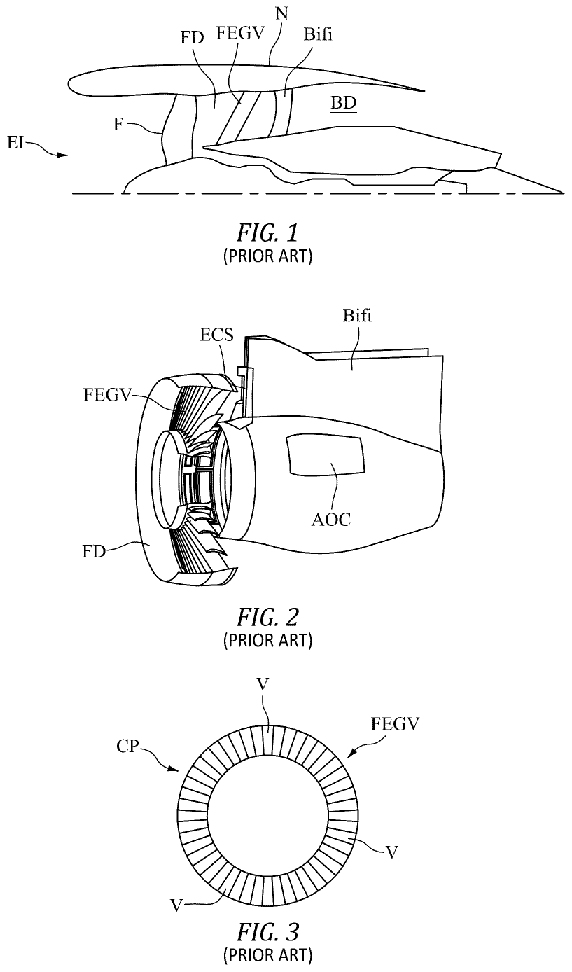

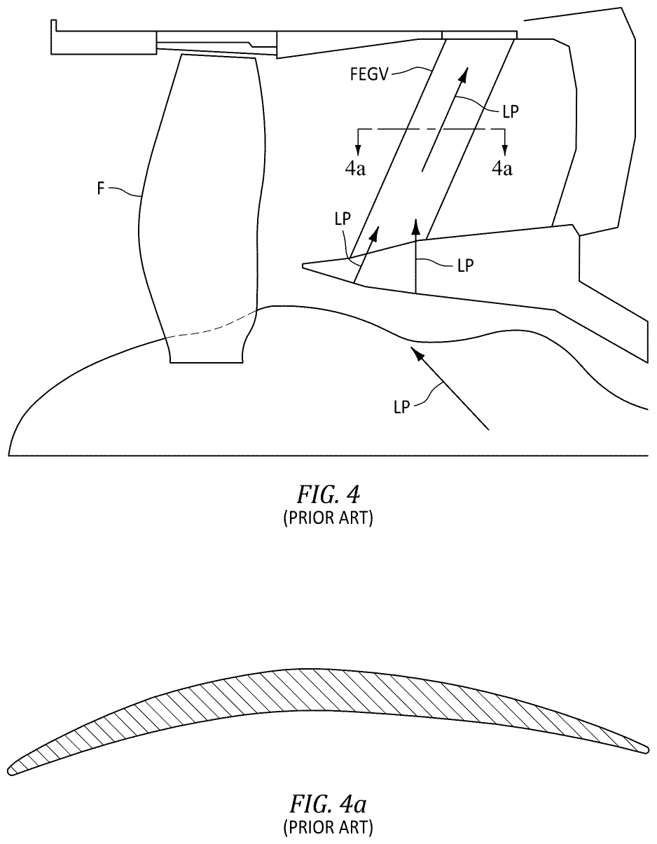

### DETAILED DESCRIPTION

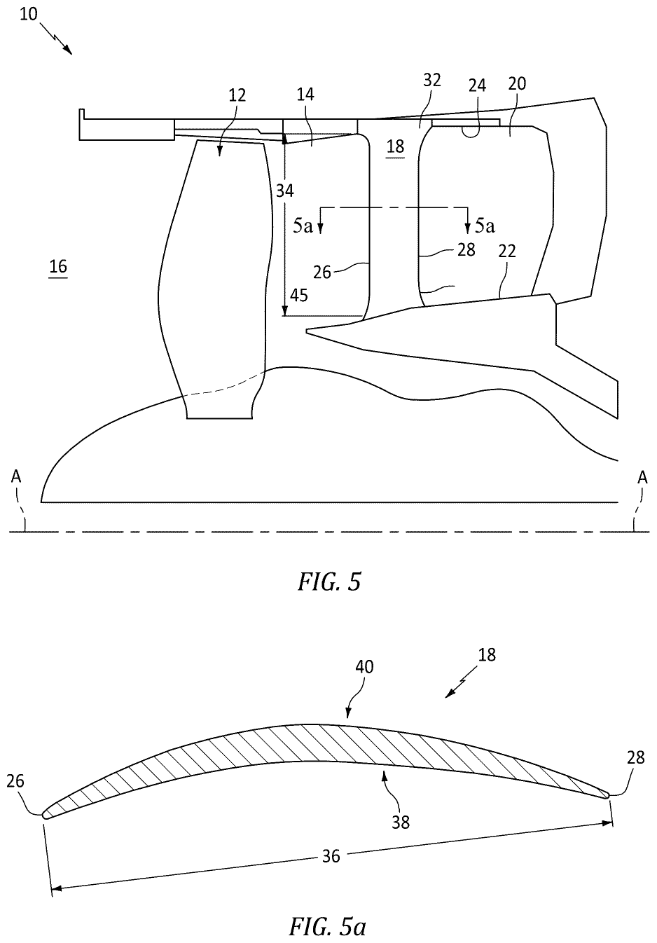

Referring now to FIG. 5 showing a schematic of a gas turbine engine 10. The gas turbine engine 10 includes a fan 12 with fan blades within a fan duct 14 proximate an engine inlet 16. Downstream from the fan 12 is a fan exit guide vane 18 upstream from a bypass duct 20.

The fan exit guide vane 18 spans across the fan duct 14 attached to a radially inner surface 22 of the fan duct 14 and a radially outer surface 24 of the fan duct 14.

With reference also to FIG. 5a, the fan exit guide vane 18 includes a leading edge 26 and a trailing edge 28 opposite chordwise from the leading edge 26.

The fan exit guide vane 18 includes a radially inner attachment region 30 proximate the radially inner surface 22. The fan exit guide vane 18 includes a radially outer attachment region 32 proximate the radially outer surface 24. The radially inner attachment region 30 is opposite spanwise from the radially outer attachment region 32. The radially inner attachment region 30 of the fan exit guide vane 18 attaches to the fan duct 14 at the radially inner surface 22 (front center body). The radially outer attachment region 32 of the fan exit guide vane 18 attaches to the fan duct 14 at the radially outer surface 24 (fan case).

The fan exit guide vane 18 includes a span 34 dimension extending between the radially inner attachment region 30 and the radially outer attachment region 32. The fan exit guide vane 18 includes a chord dimension 36 extending between the leading edge 26 and the trailing edge 28, as seen in FIG. 5a. The fan exit guide vane 18 includes a pressure side 38 opposite a suction side 40.

The fan exit guide vane 18 shown in FIG. 5 is oriented generally vertical, that is along a similar radial span between the radially inner surface 22 and radially outer surface 24 relative to the axis A. Alternatively, the fan exit guide vane 18 can include a canted orientation. In an exemplary embodiment, the vane stacking axis can be canted aft, that is the radially inner attachment region 30 is forward of the radially outer attachment region 32.

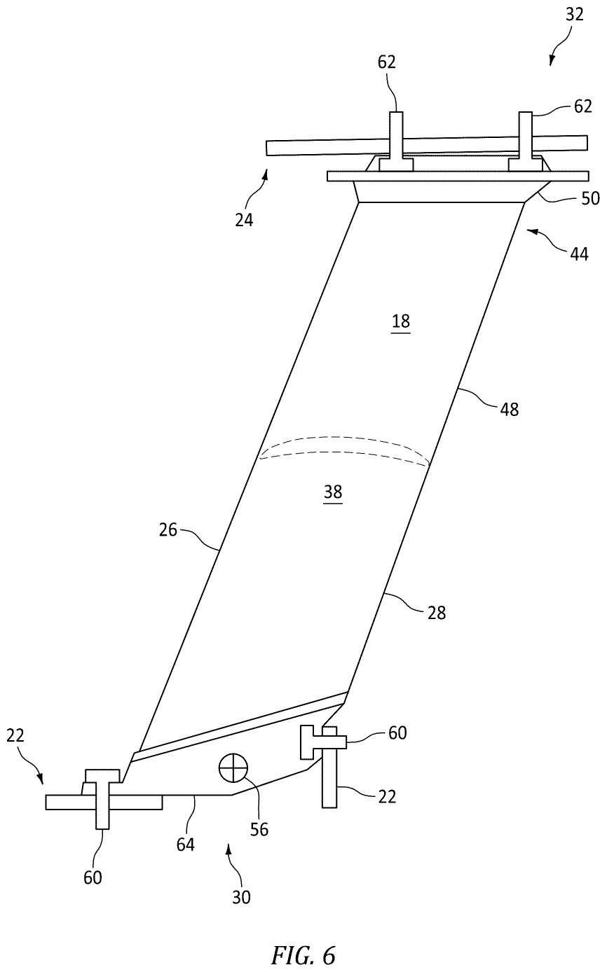

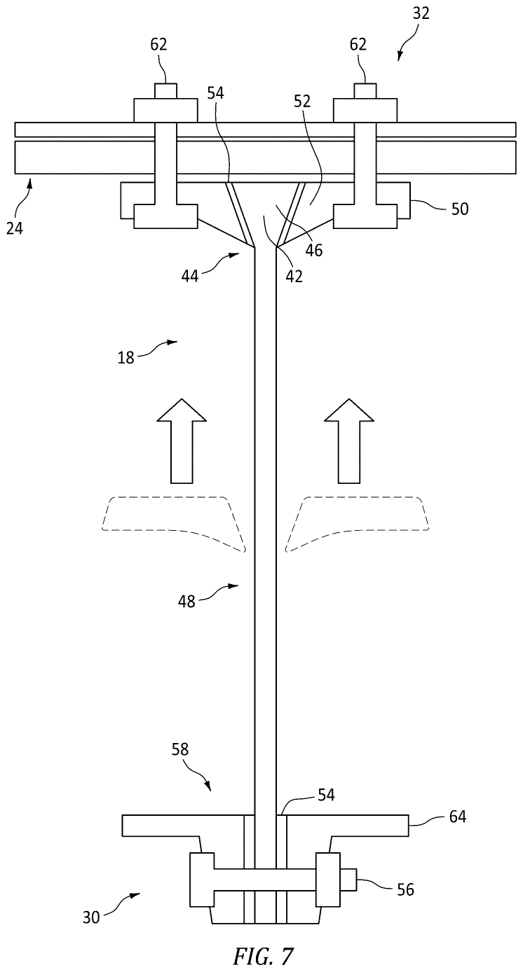

Referring also to FIG. 6 and FIG. 7, an exemplary fan exit guide vane 18 is shown. The fan exit guide vane 18 can be constructed from composite materials, such as a carbon/epoxy or thermoplastic copolyester (TPC). The fan exit guide vane 18 can include a dovetail section 42 formed in the fan exit guide vane 18 at an outer portion 44 of the fan exit guide vane 18. The dovetail section 42 can be shaped as a wedge 46 in cross section as shown in FIG. 7. The wedge 46 shape gradually increases radially outward from an airfoil section 48.

A shoe member 50 can be in operative communication with the dovetail section 42. The shoe member 50 can include a receiver 52. The receiver 52 is configured to couple with the dovetail section 42 wedge 46. The receiver 52 includes a shape that cooperates with the wedge 46. The receiver 52 can slide over the wedge 46 and form an interference fit between the shoe member 50 and the dovetail section 42. The shoe member 50 can be formed as a single unit or as multiple pieces. By compressing the shoe member 50 onto the dovetail section 43 the wedge 46 provides an increasingly tighter fit.

An adhesive 54 can be employed to adhere the shoe member 50 to the dovetail section 42. The adhesive 54 can be compatible with the structural and environmental conditions experienced by the fan exit guide vane 18. The adhesive 54 can also be employed proximate the radially inner attachment region to secure the fan exit guide vane 18. The adhesive 54 can have a thickness of between 5 to 40 mils.

A failsafe fastener 56 can be attached to the fan exit guide vane 18 proximate an inner portion 58 of the fan exit guide vane 18. The failsafe fastener 56 can be a threaded bolt and nut arrangement or other forms of fastener. The failsafe fastener 56 can be attached near the radially inner attachment region 30. The failsafe fastener 56 can be configured to prevent pullout of the fan exit guide vane 18 during predetermined gas turbine engine 10 conditions.

The fan exit guide vane 18 can be fastened and secured at both the radially inner attachment region 30 and the radially outer attachment region 32. Radially inner attachment fasteners 60 can be employed proximate the radially inner attachment region 30. Radially outer attachment fasteners 62 can be employed proximate the radially outer attachment region 32. The radially outer attachment fasteners 62 can be attached to the shoe member 50.

A boot 64 can be employed to attach the fan exit guide vane 18 with the radially inner surface 22 proximate the radially inner attachment region 30. The boot 64 can be formed as a single unit or as multiple units. The boot 64 can be configured to receive the inner portion 58 of the fan exit guide vane 18. The boot 64 can couple with the failsafe fastener 56. The boot 64 can couple with the inner portion 58 employing the adhesive 54. The boot 64 can couple with the radially inner attachment fasteners 60 to secure the fan exit guide vane 18 with the radially inner surface 22.

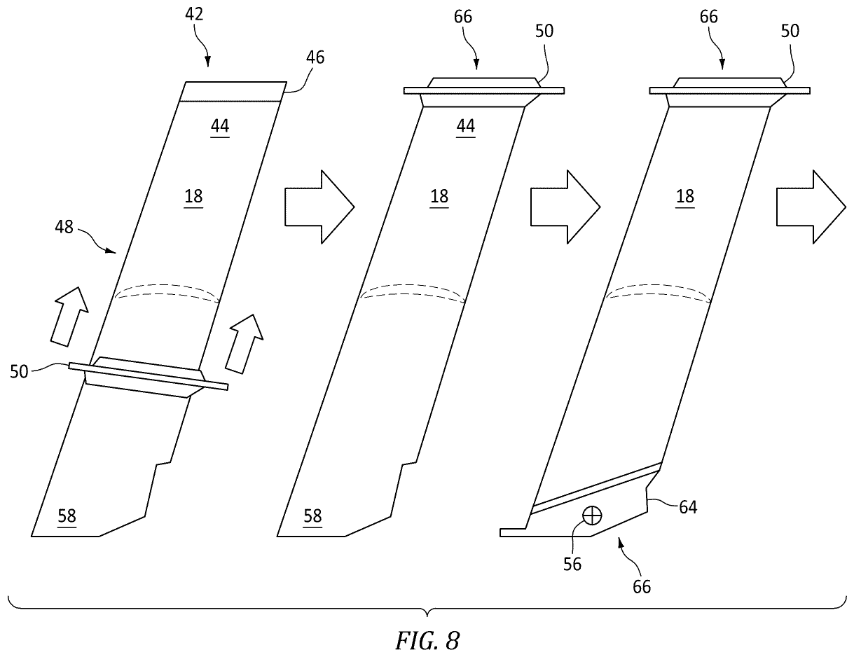

Referring also to FIG. 8, the sequence of the assembly of the shoe member 50 and the boot 64 with the fan exit guide vane 18 is shown. The shoe member 50 is shown sliding over the fan exit guide vane 18 from the inner portion 58 past the airfoil section 48 toward the dovetail section 42 near the outer portion 44. The shoe member 50 is secured against the wedge 46 of the dovetail section 42.

The adhesive 54 can be employed to secure the shoe member 50 to the dovetail section 42. The boot 64 is attached to the fan exit guide vane 18 proximate the inner portion 58. The adhesive 54 can be employed to secure the boot 64 to the inner portion 58. The failsafe fastener 56 can be secured to both the fan exit guide vane 18 and the boot 64. The entire assembly of the fan exit guide vane 18 along with locking features 66 comprising the shoe member 50, the boot 64, the failsafe fastener 56 and the adhesive 54 can be attached to the radially out attachment region 32 and radially inner attachment region 30 respectively.

A technical advantage of the disclosed composite vane with mechanical locking feature includes a mechanical locking mechanism in joints with limited adhesive bond area, preventing vane pull-out during a fan blade off event.

Another technical advantage of the disclosed composite vane with mechanical locking feature includes a significant joint strength increase without increasing weight or part count.

Another technical advantage of the disclosed composite vane with mechanical locking feature includes enabling the use of structural composite vanes instead of metallic vanes which provides a significant weight reduction in commercial engine applications.

Another technical advantage of the disclosed composite vane with mechanical locking feature includes vanes which are line removable and can be installed as replacements for existing metallic vanes.

Another technical advantage of the disclosed composite vane with mechanical locking feature includes no advanced machining required with standard tolerances.

Another technical advantage of the disclosed composite vane with mechanical locking feature includes no unique architecture changes for mounting locations such as the fan case and the front center body.

There has been provided a composite vane with mechanical locking feature. While the composite vane with mechanical locking feature has been described in the context of specific embodiments thereof, other unforeseen alternatives, modifications, and variations may become apparent to those skilled in the art having read the foregoing description. Accordingly, it is intended to embrace those alternatives, modifications, and variations which fall within the broad scope of the appended claims.

1. A composite vane with a locking feature comprising:
a leading edge and a trailing edge opposite chordwise from the leading edge; a radially inner attachment region opposite spanwise from a radially outer attachment region;
a span dimension extending between the radially inner attachment region and the radially outer attachment region;
a chord dimension extending between the leading edge and the trailing edge; a pressure side opposite a suction side of the composite vane;
a dovetail section formed monolithic within the composite vane proximate the radially outer attachment region;
a shoe member in operative communication with the dovetail section;
a boot in operative communication with an inner portion opposite spanwise from the dovetail portion; and
a failsafe fastener comprising a threaded bolt and nut arrangement in operative communication with the boot and the inner portion of the composite vane.

2. The composite vane with the locking feature according to claim 1, wherein the shoe member comprises a receiver, the receiver is configured to couple with the dovetail section.

3. The composite vane with the locking feature according to claim 1, wherein the dovetail section comprises a wedge portion, the wedge portion being configured to cooperate with the receiver to form an interference fit between the shoe member and the dovetail section.

4. The composite vane with the locking feature according to claim 1, wherein the boot is configured to receive the inner portion of the composite vane.

5. The composite vane with the locking feature according to claim 1, further comprising:
an adhesive in operative communication between the shoe member and the dovetail section.

6. The composite vane with the locking feature according to claim 1, wherein the shoe member is configured slidable onto the dovetail section.

7. The composite vane with the locking feature according to claim 1, wherein the boot is configured to couple with the failsafe fastener and configured to couple with the inner portion with an adhesive.

8. A fan exit guide vane system with a locking feature for a gas turbine engine, the fan exit guide vane system comprising:
a fan located within a fan duct; and
an array of composite fan exit guide vanes supported within the fan duct downstream from the fan, the array of composite fan exit guide vanes span across the fan duct attached to a radially inner surface of the fan duct and a radially outer surface of the fan duct;
wherein each composite fan exit guide vane of the array of composite fan exit guide vanes comprises:
a leading edge and a trailing edge opposite chordwise from the leading edge; a radially inner attachment region opposite spanwise from a radially outer attachment region;
a span dimension extending between the radially inner attachment region and the radially outer attachment region;
a chord dimension extending between the leading edge and the trailing edge; a pressure side opposite a suction side of the composite fan exit guide vane;
a dovetail section formed monolithic within the composite fan exit guide vane proximate the radially outer attachment region;
a shoe member in operative communication with the dovetail section;
a boot in operative communication with an inner portion opposite spanwise from the dovetail portion;
an adhesive in operative communication between the shoe member and the dovetail section, the adhesive in operative communication between the boot and the inner portion; and
a failsafe fastener formed as a threaded bolt and nut arrangement in operative communication with the boot and the inner portion of the composite fan exit guide vane.

9. The fan exit guide vane system with a locking feature for a gas turbine engine according to claim 8, wherein the shoe member comprises a receiver, the receiver is configured to couple with the dovetail section.

10. The fan exit guide vane system with a locking feature for a gas turbine engine according to claim 8, wherein the dovetail section comprises a wedge portion, the wedge portion being configured to cooperate with the receiver to form an interference fit between the shoe member and the dovetail section.

11. The fan exit guide vane system with a locking feature for a gas turbine engine according to claim 8, wherein the boot is configured to receive the inner portion of the composite vane.

12. The fan exit guide vane system with a locking feature for a gas turbine engine according to claim 8, wherein the boot is configured to couple with the failsafe fastener.

13. The fan exit guide vane system with a locking feature for a gas turbine engine according to claim 8, wherein the shoe member is configured slidable onto the dovetail section.

14. A process for a composite fan exit guide vane with a locking feature comprising:
locating a fan within a fan duct;
supporting an array of composite fan exit guide vanes within the fan duct downstream from the fan;
attaching the array of composite fan exit guide vanes spanned across the fan duct to a radially inner surface of the fan duct and a radially outer surface of the fan duct;
coupling a radially inner attachment region of each composite fan exit guide vane of the array of composite fan exit guide vanes in operative communication with the radially inner surface of the fan duct;
coupling a radially outer attachment region of each composite fan exit guide vane of the array of composite fan exit guide vanes in operative communication with the radially outer surface of the fan duct;
forming a dovetail section within the composite fan exit guide vane proximate the radially outer attachment region;
coupling a shoe member in operative communication with the dovetail section;
coupling a boot in operative communication with an inner portion opposite spanwise from the dovetail portion;
attaching an adhesive in operative communication between the shoe member and the dovetail section, the adhesive in operative communication between the boot and the inner portion; and
coupling a failsafe fastener in operative communication with the boot and the inner portion of the composite fan exit guide vane.

15. The process of claim 14, further comprising:
forming a receiver in the shoe member; and
configuring the receiver to couple with the dovetail section.

16. The process of claim 14, further comprising:
forming a wedge portion in the dovetail section;
configuring the wedge portion to cooperate with the receiver; and
forming an interference fit between the shoe member and the dovetail section.

17. The process of claim 14, further comprising:
configuring the boot to receive the inner portion of the composite vane.

18. The process of claim 14, further comprising:
coupling the boot with the failsafe fastener.

19. The process of claim 14, further comprising:
configuring the shoe member slidable onto the dovetail section.

20. The process of claim 14, further comprising:
employing radially inner attachment fasteners proximate the radially inner attachment region;
employing radially outer attachment fasteners proximate the radially outer attachment region;
attaching the radially outer attachment fasteners to the shoe member; and
coupling the boot with the radially inner attachment fasteners to secure the composite fan exit guide vane with the radially inner surface.
